(19) United States
(12) Patent Application Publication
(10) Pub. No.: US 2015/0006425 A1
(43) Pub. Date: Jan. 1, 2015

(54) SYSTEMS AND METHODS FOR GENERATING VISUALIZATIONS INDICATIVE OF LEARNER PERFORMANCE IN AN eLEARNING SYSTEM

(71) Applicants: Hanan Ayad, Kitchener (CA); Alfred Essa, Kitchener (CA); Khaled Hammouda, Kitchener (CA); Steve Schoger, Kitchener (CA); Shady Shehata, Kitchener (CA)

(72) Inventors: Hanan Ayad, Kitchener (CA); Alfred Essa, Kitchener (CA); Khaled Hammouda, Kitchener (CA); Steve Schoger, Kitchener (CA); Shady Shehata, Kitchener (CA)

(21) Appl. No.: 14/317,584

(22) Filed: Jun. 27, 2014

Related U.S. Application Data
(60) Provisional application No. 61/840,821, filed on Jun. 28, 2013.

(51) Int. Cl. G06Q 50/20; G06Q 10/00; G09B 5/00

(52) U.S. Cl. CPC G06Q 50/2057; G09B 5/00; G06Q 10/00
USPC 705/328

(57) ABSTRACT

An electronic learning system for generating at least one visualization in relation to a plurality of learners. The system includes at least one data storage device storing learner data and class data, the learner data having a plurality of performance aspects associated with each learner and class data being associated with the plurality of learners, and at least one processor in data communication with the at least one data storage device. The at least one processor adapted to receive the learner data and the class data, generate at least one visualization indicative of performance of each learner in relation to the plurality of learners based upon the learner data and class data, the at least one visualization including multiple graphical features, each of the graphical features being indicative of one of the performance aspects of the learner relative to class data, and display the at least one visualization.

### RELATED APPLICATIONS

This application claims the benefit of U.S. Provisional Patent No. 61/840,821, filed Jun. 28, 2013, the entire contents of which are hereby incorporated by reference herein for all purposes.

### TECHNICAL FIELD

The embodiments herein relate to electronic learning (“eLearning”) systems, and in particular to monitoring activities of one or more learners in a course in the eLearning system and predicting performance of the same.

### BACKGROUND

Electronic learning (also called e-Learning or eLearning) generally refers to education or learning by which users (e.g., learners, instructors, administrative staff) engage in education related activities using computers and other computing devices. For examples, learners may enroll or participate in a course or program of study offered by an educational institution (e.g., a college, university or grade school) through a web interface that is accessible over the Internet. Similarly, learners may electronically receive assignments, participate in group work and projects by collaborating online, and be graded based on assignments and examinations that are submitted using an electronic dropbox.

Electronic learning is not limited to use by educational institutions. For example, electronic learning may also be used in governments or in corporate environments. For example, employees at a regional branch office of a particular company may use electronic learning to participate in a training course offered by the company's head office without ever physically leaving the regional branch office.

Electronic learning can also be an individual activity with no institution driving the learning. For example, individuals may participate in self-directed study (e.g., studying an electronic textbook or watching a recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Furthermore, because course materials can be offered and consumed electronically, there are fewer physical restrictions on learning. For example, the number of learners that can be enrolled in a particular course may be practically limitless, as there may be no requirement for physical facilities to house the learners during lectures. Furthermore, learning materials (e.g., handouts, textbooks, etc.) may be provided in electronic formats so that the learning materials can be reproduced for a virtually unlimited number of learners. Finally, lectures may be recorded and accessed at varying times (e.g., at different times that are convenient for different users), thus accommodating users with varying schedules, and allowing users to be enrolled in multiple courses that might have a scheduling conflict when offered using traditional techniques.

Although electronic learning systems have a lot of advantages over traditional learning systems, electronic learning systems may also have some drawbacks. For example, the learners in the electronic learning systems (in contrast to traditional “brick and motor” learning) do not regularly attend physical classrooms for in-person interactions with other learners or their instructors. As such, it may be difficult for an instructor to determine the degree to which the learners are engaged, and to identify which learners are at-risk of not succeeding in the course. Furthermore, even if the instructors are aware that some learners are at-risk, it may be difficult for the instructor to diagnose why these learners are at-risk to determine the appropriate corrective action, as the instructors usually do not regularly interact with these learners in person.

### BRIEF DESCRIPTION OF THE DRAWINGS

Various embodiments will now be described, by way of example only, with reference to the following drawings, in which:

FIG. 1 is a schematic diagram of an electronic learning system for monitoring and predicting user performance according to some embodiments;

FIG. 2 is a schematic diagram illustrating various modules provided by an electronic learning system such as, for example, the system illustrated in FIG. 1;

FIG. 3 is an exemplary screen including some visualizations that may be generated by a module such as, for example, the visualization module shown in FIG. 2;

FIG. 4 is an exemplary screen including some visualizations that may be generated by a module such as, for example, the visualization module shown in FIG. 2;

FIG. 5 is an exemplary screen including some visualizations that may be generated by a module such as, for example, the visualization module shown in FIG. 2;

FIG. 6 is an exemplary screen including some visualizations that may be generated by a module such as, for example, the visualization module shown in FIG. 2; and

FIG. 7 is a schematic diagram illustrating steps of a method for generating visualizations in an electronic learning system according to some embodiments.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

In some embodiments, it is desirable to identify at-risk learners so that corrective action, if necessary, could be applied to those learners to improve their likelihood of success. It may also be desirable to identify such at-risk learners at earlier stages of one or more courses as this would provide an at-risk learner more time to improve the learner's respective likelihood of success in courses in which the learner is at-risk.

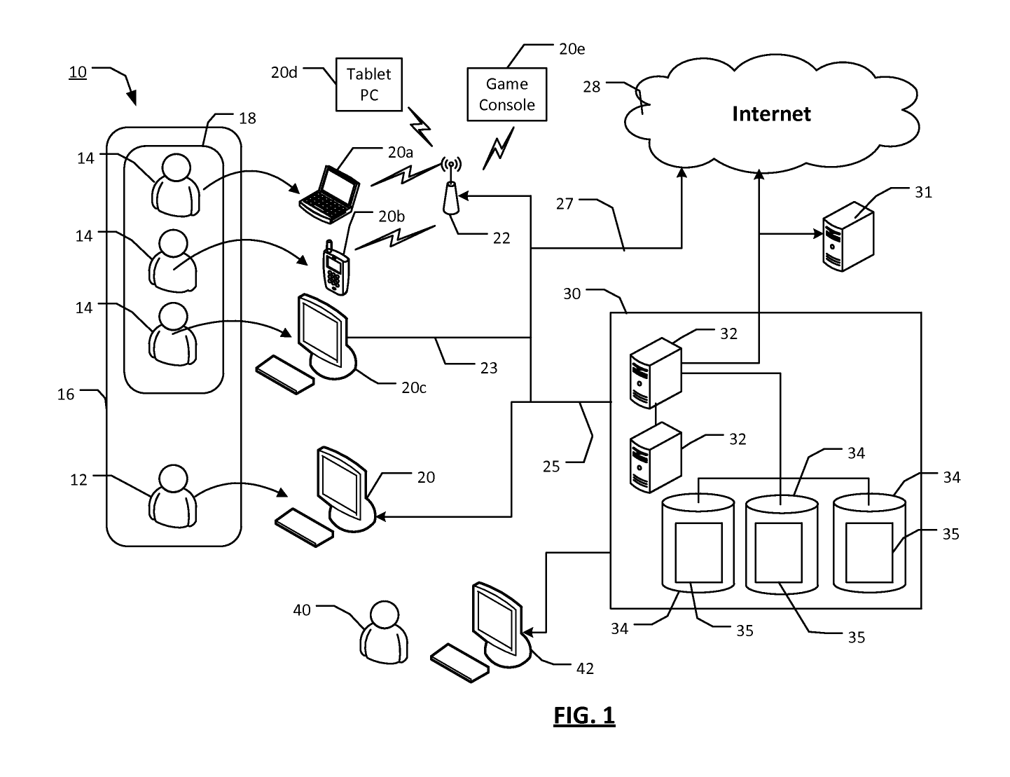

Referring now to FIG. 1, illustrated therein is a system 10 for monitoring and predicting user performance according to some embodiments. The system 10 as shown is an electronic learning system or eLearning system. However, in other instances the system 10 may not be limited to electronic learning systems and it may be other types of systems.

Using the system 10, one or more users 12, 14 may communicate with an educational service provider 30 to participate in, create, and consume electronic learning services, including educational courses. In some cases, the educational service provider 30 may be part of (or associated with) a traditional “bricks and mortar” educational institution (e.g., a grade school, a university, a college, and the like), another entity that provides educational services (e.g., an online university, a company that specializes in offering training courses, an organization that has a training department, and the like), or may be an independent service provider (e.g., for providing individual electronic learning).

It should be understood that a course is not limited to courses offered by formal educational institutions. The course may include any form of learning instruction offered by an entity of any type. For example, the course may be a training seminar at a company for a group of employees or a professional certification program (e.g., PMP, CMA, and the like) with a number of intended participants.

In some embodiments, one or more educational groups can be defined that includes one or more of the users 12, 14. For example, as shown in FIG. 1, the users 12, 14 may be grouped together in an educational group 16 representative of a particular course (e.g., History 101, French 254, and the like), with a first user 12 or “instructor” being responsible for organizing and/or teaching the course (e.g., developing lectures, preparing assignments, creating educational content, and the like), while the other users 14 or “learners” are consumers of the course content (e.g., users 14 are enrolled in the course).

In some embodiments, the users 12, 14 may be associated with more than one educational group (e.g., the users 14 may be enrolled in more than one course, a user may be enrolled in one course and be responsible for teaching another course, a user may be responsible for teaching a plurality of courses, and so on).

In some embodiments, educational sub-groups may also be formed. For example, the users 14 are shown as part of educational sub-group 18. The sub-group 18 may be formed in relation to a particular project or assignment (e.g., sub-group 18 may be a lab group) or based on other criteria. In some embodiments, due to the nature of the electronic learning, the users 14 in a particular sub-group 18 need not physically meet, but may collaborate together using various tools provided by the educational service provider 30.

In some embodiments, other groups 16 and sub-groups 18 could include users 14 that share common interests (e.g., interests in a particular sport), that participate in common activities (e.g., users that are members of a choir or a club), and/or have similar attributes (e.g., users that are male, users under twenty-one years of age, and the like).

Communication between the users 12, 14 and the educational service provider 30 can occur either directly or indirectly using any one or more suitable computing devices. For example, the user 12 may use a computing device 20 having one or more client processors such as a desktop computer that has at least one input device (e.g., a keyboard, a mouse, and the like) and at least one output device (e.g., a display screen, speakers, and the like).

The computing device 20 can generally be any suitable device for facilitating communication between the users 12, 14 and the educational service provider 30. For example, the computing device 20 could be a laptop 20a wirelessly coupled to an access point 22 (e.g., a wireless router, a cellular communications tower, and the like), a wirelessly enabled Personal Data Assistant (PDA) 20b or smart phone, a terminal 20c, a tablet computer 20d, a game console 20e, and the like operating over a wired connection 23.

The computing devices 20 may be connected to the service provider 30 via any suitable communications channel. For example, the computing devices 20 may communicate to the educational service provider 30 over a Local Area Network (LAN) or intranet, or using an external network (e.g., by using a browser on the computing device 20 to browse to one or more web pages or other electronic files presented over the Internet 28 over a data connection 27).

In some embodiments, one or more of the users 12, 14 may be required to authenticate the user's identities in order to communicate with the educational service provider 30. For example, each of the users 12, 14 may be required to input a user identifier such as a login name, and/or a password associated with that user or otherwise identify themselves to gain access to the system 10.

In some embodiments, one or more users (e.g., “guest” users) may be able to access the system without authentication. Such guest users may be provided with limited access, such as the ability to review one or more components of the course to decide whether the user would like to participate in the course but without the ability to post comments or upload electronic files.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g., a course page).

The educational service provider 30 generally includes a number of functional components for facilitating the provision of electronic learning services. For example, the educational service provider 30 generally includes one or more processing devices such as servers 32, each having one or more processors. The processors on the servers 32 will be referred to generally as “remote processors” so as to distinguish from client processors found in computing devices (20, 20a-20e). The servers 32 are configured to send information (e.g., electronic files such as web pages) to be displayed on one or more computing devices 20 in association with the electronic learning system 10 (e.g., course information). In some embodiments, a server 32 may be a computing device 20 (e.g., a laptop, a personal computer, and the like).

The educational service provider 30 also generally includes one or more data storage devices 34 (e.g., memory, and the like) that are in communication with the servers 32, and could include a relational database (such as a SQL database), or other suitable data storage devices. The data storage devices 34 are configured to host data 35 about the courses offered by the service provider (e.g., the course frameworks, educational materials to be consumed by the users 14, records of assessments done by users 14, and the like).

The data storage devices 34 may also store authorization criteria that define what actions may be taken by the users 12, 14. In some embodiments, the authorization criteria may include at least one security profile associated with at least one role. For example, one role could be defined for users who are primarily responsible for developing an educational course, teaching the educational course, and assessing work product from other users for the educational course. Users with such a role may have a security profile that allows the users to configure various components of the educational course, post assignments, add assessments, evaluate performances, and so on.

In some embodiments, some of the authorization criteria may be defined by specific users 40 who may or may not be part of the educational community 16. For example, administrator users 40 may be permitted to administer and/or define global configuration profiles for the system 10, define roles within the system 10, set security profiles associated with the roles, assign the roles to particular users 12, 14 in the system 10, and the like. In some embodiments, the users 40 may use another computing device (e.g., a desktop computer 42) to accomplish the above-identified tasks.

The data storage devices 34 may also be configured to store other information, such as personal information about the users 12, 14 of the system 10, information about which courses the users 14 are enrolled in, roles to which the users 12, 14 are assigned, particular interests of the users 12, 14 and so on.

The servers 32 and data storage devices 34 may also provide other electronic learning management tools (e.g., allowing users to add and drop courses, communicate with other users using chat software, etc.), and/or may be in communication with one or more other vendors that provide the tools.

In some embodiments, the system 10 may also have one or more backup servers 31 that may duplicate some or all of the data 35 stored on the data storage devices 34. The backup servers 31 may be desirable for disaster recovery (e.g., to prevent undesired data loss in the event of an event such as a fire, flooding, or theft). In some embodiments, the backup servers 31 may be directly connected to the educational service provider 30 but located within the system 10 at a different physical location.

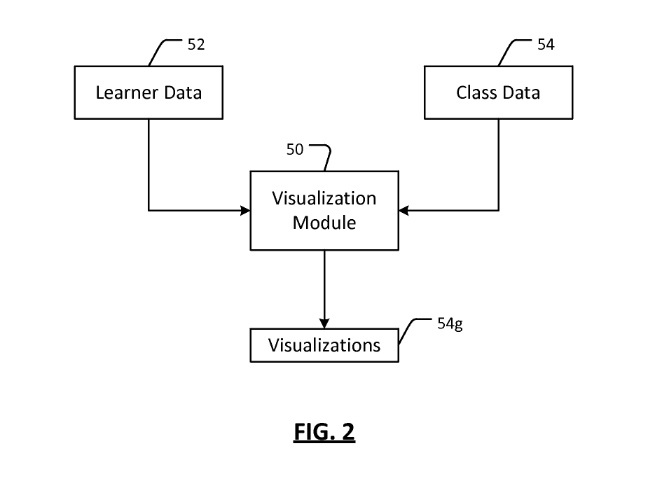

Referring now to FIG. 2, illustrated therein a schematic diagram of some modules that may be implemented by one or more processors of the system 10 according to some embodiments. In particular, one or more processors (not shown) may be configured to provide visualization module 52 and/or other modules described herein below. In some embodiments, the processors may be the processors on the servers 32 shown in FIG. 1. It should be understood that these modules are provided only to illustrate exemplary logical organization of how the one or more processors may be configured. In other embodiments, one or more of these modules may be combined with each other or with one or more other modules, or the processor(s) may be configured to provide one or more functionalities of the modules described herein without using any modules.

The visualization module 52 receives learner data 54 and class data 56. The learner data 54 includes information about various performance aspects associated with a given learner. The performance aspects of a given learner may include various learner engagement activities and/or other performance indicators such as learner academic performance.

In some embodiments, the learner data 54 may be, either wholly or partially, generated from various learner engagement activities. Generating the learner data 54 is described in further detail in U.S. Provisional Patent Application Nos. 61/548,135 and 61/661,190 filed Oct. 17, 2011 and Jul. 9, 2012, respectively, and U.S. patent application Ser. No. 13/652,765 filed Oct. 16, 2012. The content of the above noted applications in their entirety are hereby incorporated by reference herein for all purposes.

One exemplary performance aspect of the learner that may be included in learner data 54 is academic performance information associated with the learner such as the learner's grades. The learner's grades may be obtained from one or more assessments that the learner has completed previously, either in association with a current course or in association with historical courses.

Another exemplary performance aspect of the learner that may be included in learner data 54 is attendance data indicative of how often the learner accesses the course. The attendance data, which may also be referred to as “course access data” may be obtained from frequency of log-ins or attendance of live broadcast of lectures and the length of each log-in session.

Another exemplary performance aspect of the learner that may be included in learner data 54 is content access data indicative of a volume of content associated with the course that is accessed by the learner. The content access data may be obtained by monitoring learner access to various content data associated with a course. For example, the content access data could be monitored whether the learner accesses the reading material, views a recorded lecture, or otherwise accesses or consumes a learning resource associated with the course.

Another exemplary performance aspect of the learner that may be included in learner data 54 is social learning data indicative of social connectedness of the learner to the learner's peers. The social learning data may be obtained from metadata associated with various communications between the learner and the learner's peers.

Another exemplary performance aspect of the learner that may be included in learner data 54 is a success index associated with the learner. The success index is a prediction of how likely the learner is going to be successful (or at risk of being unsuccessful) in the course. The success index may be generated from one or more other learner engagement activities and/or other learner data 54 based upon one or more hypothesis as to which performance aspects of the learner data 54 better predicts success (or failure) of the learner.

In addition to the learner data 54, the visualization also receives class data 56. The class data 56 includes data associated with peers of the learner. The peer group for the learner may include earners who are currently completing or had previously completed the same course. The peer group, in another example, may include learners who are similar in ability to the current learner as determined based upon educational profile of the current learner. In some cases, the peer group may be defined automatically or defined with input from another suitable (e.g., an administrator, an instructor, and the like).

The class data 56 may also include various performance aspects of the peers associated with the learner. For example, class data 56 may include academic performance information such as grades associated with other learners in the class. The academic information may include distribution of the grades. The class data 56 may also include course access data or attendance data associated with other learners who are part of the learner's peer group. The class data 56 may also include content access data indicative of an amount content associated with the course that is accessed by the other learners. The class data 56 may also include social learning data indicative of social connectedness of the other learners. The class data 56 may also include a success index associated with the other learners.

Upon receiving learner data 54 and class data 56, the visualization module 52 is configured to generate one or more visualization based upon the learner data and the class data. The visualization conveys the learner data 54 and class data 56 in an abstracted manner to one or more users (e.g., the instructor) to encourage efficient understanding of the student's performance in relation to class performance.

Each of the visualization generated by the visualization module 52 includes a plurality of graphical features that are integrated with one another to convey plurality of types of information to a viewer using a single integrated visualization.

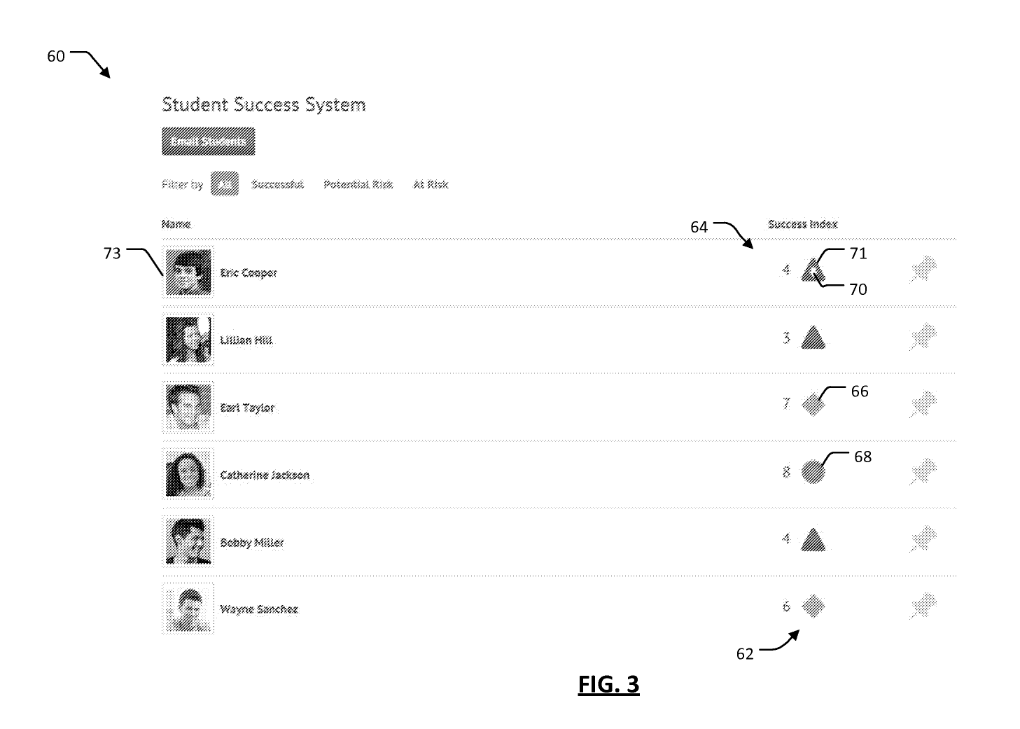

Referring now to FIG. 3 illustrated therein is screen 60 that may be generated by one or more processors of the learning system 10. The screen 60 conveys, at a glance, predicted success of a plurality of learners in a given course. This screen may allow an instructor to efficiently understand which of the students in the class are struggling. To convey this information in a succinct manner, the screen 60 includes a plurality of visualizations according to some embodiments, which may be referred to as “success indicators” 62.

Each of the success indicators 62 is selected from one of three graphical features, which in the embodiment as shown are three icons. The icons include a triangle 64, a diamond 66, and a circle 68. It should be understood that in other shapes or designs for icons could be used as graphical features in other implementations as long as the features are distinguishable from each other.

In the embodiment as shown, the graphical feature also incorporate use of three distinct colours, namely green, amber, and red. A combination of the colour and the icon is used to convey the status of the success index for each learner. While use of a second distinguishing graphical feature is not necessary, the second distinguishing graphical feature may help communicate the information more readily to one or more users as it may be easier for some individuals to perceive colours.

The circular icon 68 and the green colour may be used to indicate that a learner is predicted to be successful (or not at risk for failure). The diamond icon 66 and the colour amber is used to indicate that a learner is marginally at risk of under-performing, and the triangle icon 64 and the red colour may be used to indicate that a learner is at risk of failing (or underperforming).

The visualization may also include a change indicator, which in this example is an arrow 70. The arrow 70 may be pointing upwardly as shown to indicate improvement or pointing downwardly to indicate that the learner's prediction has worsened compared to the previous time the success index was generated. Lack of a change indicator may be perceived as having no material change in the learner's success index.

Each of the visualizations includes integrated graphical features that illustrate multiple data types. The visualizations include various icons, colours and change indicator, which are used to convey success index and change in the success index. The success index values are themselves generated from various types of data as described herein above.

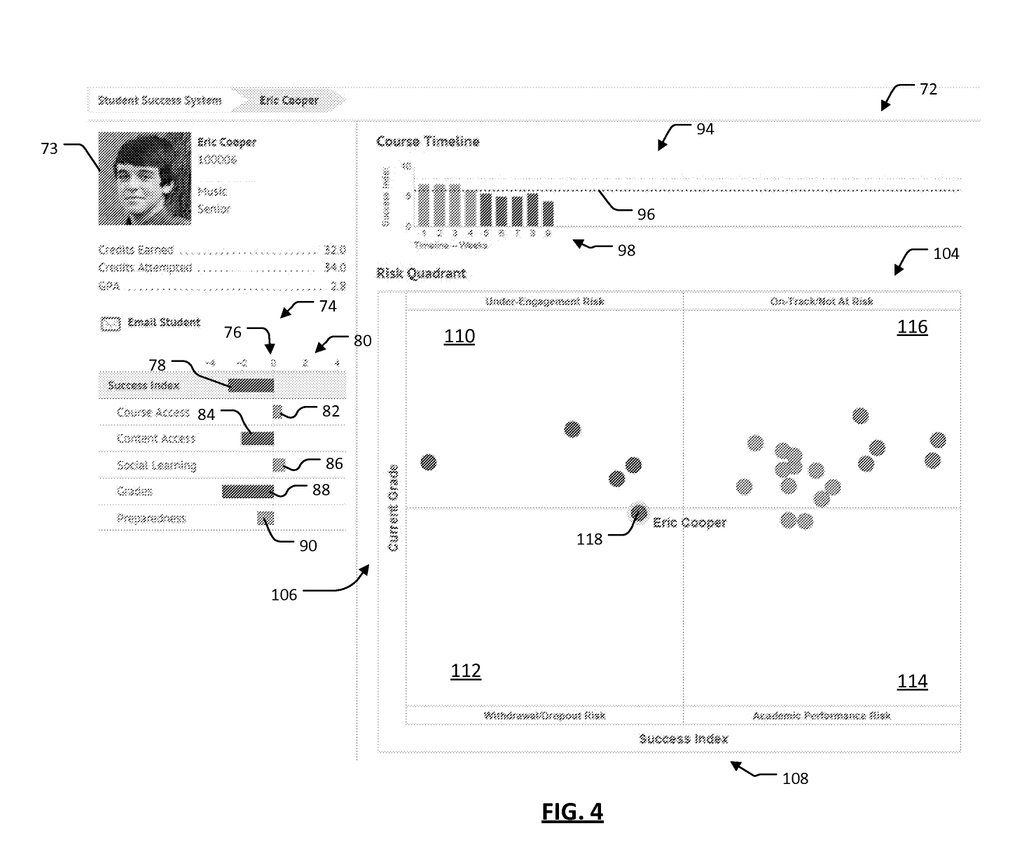

Referring now to FIG. 4, illustrated therein is another screen 72 that may be generated by one or more processors of the system 10. The screen 72 may be generated when a user interact with the icon 71 associated with learner 73. The screen 72 includes a visualization according to some embodiments, which may be referred to as loss-gain chart or a win-loss chart 74. The loss-gain chart 74 includes a plurality of integrated graphical features that are used to convey success index of a given learner relative to other learners in the class.

The loss-gain chart 74 includes an axis 80 which includes an origin location 76. The success index as well as other information (e.g., course access, content access, social learning, grades, and preparedness) are plotted using a bar graph relative to a starting point. The “0” mark 76 and line that extends downwardly represents a comparison point against which the learner's scores are compared. For example, the mark 76 may represent the average value of the class, and the position of the bar 78 may represent whether the score for that category is below or above the class average. The mark 76, in other examples, may represent a median value, a mean value or any suitable value. Furthermore, the distance between the end of the bar 78 and the mark 76 may represent how far behind (or ahead) the learner is compared to the class average. The values on the axis 80 may be used to represent standard deviations from the class average. In other embodiments, the values may represent the success index value. In some embodiments, the values may be plotted against the learner's historical values.

In addition to the bar 78, each of the other type of information is illustrated using other bars. In particular, the course access data is illustrated using bar 82, the content access data is illustrated using bar 84, the social learning data is illustrated using bar 86, the grades data is illustrated using bar 88 and the learner preparedness data is illustrated using bar 90. Each of the bars 85-90 may also be colour coded (or otherwise visually indicated) so as to convey the importance of the information being conveyed by the bar. For example, the bar may be conveyed using a red colour when the information indicate the student at risk, a amber colour when the information indicates that the student is marginally at risk, and green colour when the information indicates that the student is on track (or not at risk).

The visualization 74 includes integrated graphical features (e.g., axis, origin marker, bars, and the like) that illustrate multiple data types. For example, the class average may be illustrated using the mark 76 and the line that extends downwardly therefrom. The values on the axis 80 is used to indicate the learner's status in various data types in comparison to the class average.

By providing multiple data types in a readily accessible graphical visualization, an instructor may readily determine the reason as to why the learner is determined to be at risk (e.g., low success index value). In the example as shown, the learner is currently at risk of not succeeding as indicated by the success index bar 78 and icon 71 shown in FIG. 3. The loss-gain chart 74 further illustrates the reasons for the at-risk assessment. For example, although the learner 73 is above class average in the course access and social learning data types, the learner 73 is below average in content access, grades and preparedness. This instructor may infer from this data that the learner 73 needs extra encouragement to access the course content and perhaps suggest additional remedial course material for the learner 73 to address his lack of preparedness.

According to another embodiment, in addition to the loss-gain chart visualization 74, the screen 72 may also include another visualization, namely a success index change graph 94.

The graph 94 illustrates values of the success index over a period time. In this case, the change in success value over a period of nine weeks is illustrated. The line 96 indicates the class average and the bars 98 represent the value of the success index associated with the learner 93 at each week. In other embodiments, the line 96 may indicate a median value, a mean value, or another suitable comparison value. As shown, the learner 93 has an above average success index in weeks 1-3. However, after week, the learner's average success index has decreased to below class average. By observing the graph 94, an instructor may hypothesize that there may have been one or more issues that influenced the learner in week 4 and after week 4 that may be relevant to the decrease in success index. The instructor may then work with the learner to take appropriate remedial action.

According to some embodiments, the screen 72 also includes another visualization, namely a risk graph 104. The risk graph 104 includes a plurality of integrated graphical features that illustrate multiple data types. The graphical features include division of the graph 104 into four quadrants over two axes.

A first axis 106, which in this case is the vertical axis, is indicative of current academic performance (e.g., one or more current grades) of various learners. A second axis 108, which in this case is the horizontal axis, is indicative of the success index value of various learners. The learners in a course are plotted within the graph based upon their current grade and success index value using colour coded circular icons.

Each of the icons represents a learner. The number of learners plotted on the risk graph may be configurable. For example, learners associated with a class, course, department, faculty, institution, or any other suitable grouping may be shown in the graph 104. sand The colour of the icon indicates risk level associated with the learner. For example, icons plotted in red may indicate that the learner is at risk of not succeeding, the icons in amber may indicate that the learner is marginally at risk of not succeeding, and the icons in green may indicate that the learner is not at risk, for example, as determined based upon historical data. As shown, the learner 73 is plotted using icon 118 using a red colour to indicate that he is at risk.

The graph 104 is divided into four quadrants and each of the quadrants indicates a current status of the learner based upon the current grade and success index value associated with the learner. For example, learners who are within a first quadrant 110 (upper left) are at risk for under-engagement. The learners who are within a second quadrant 112 (lower left) are at risk for withdrawing from the class or dropping-out of the system. The learners who are within a third quadrant 114 (lower right) are at risk for poor academic performance (e.g. predicted to receive a grade below a defined value such as a D or F grade in the course). The learners who are located in a fourth quadrant 116 are on-track and are generally not at-risk for the above noted outcomes. As shown, the location of icon 118 suggests that the leaner 73 is marginally at risk for under engagement and withdrawal/dropout.

The risk graph 104 illustrates multiple data types using plurality graphical features to convey information to a user such as the instructor. The viewer may assess predicted success/risk of failure of the learner 73. Furthermore, the viewer may determine, from a glance, the general performance and predicted risk/success of all of the learners in the course. As such, the risk graph 104 may help determine whether the relative position of the learner 73 in comparison to other learners in the class. Furthermore, the risk graph 104 may help identify the type of help that the learner 73 may require to encourage his success.

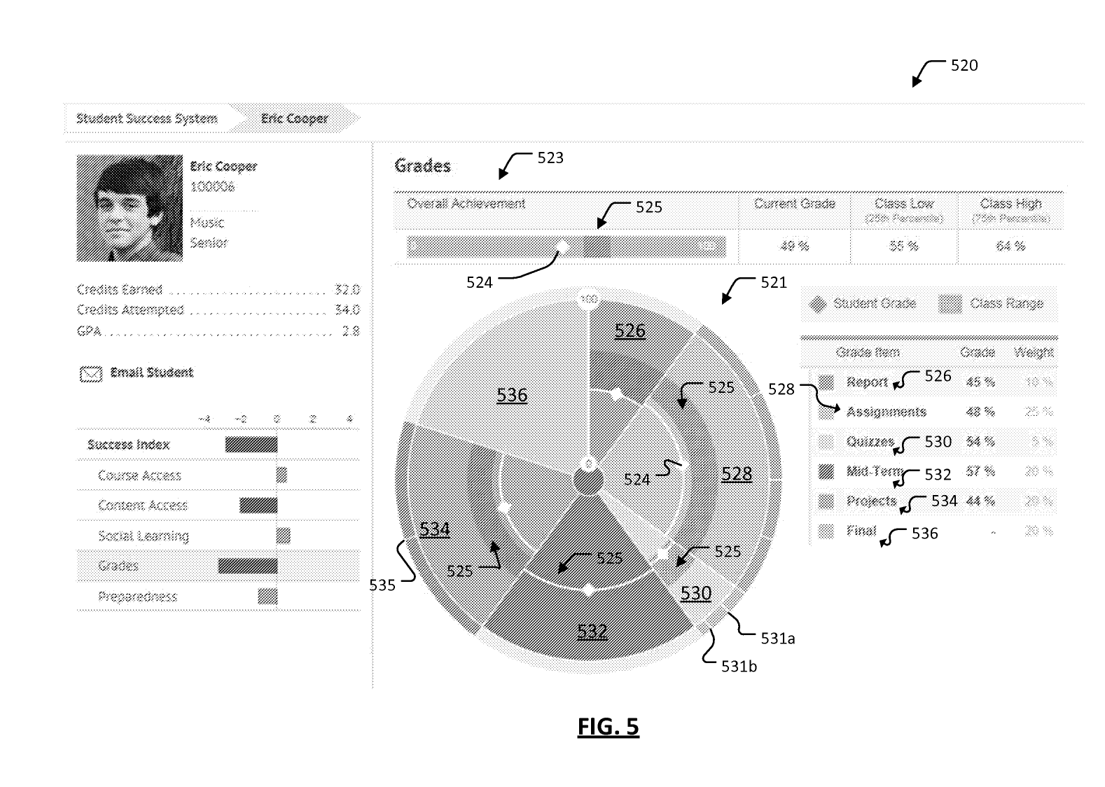

Referring now to FIG. 5, illustrated therein is a screen 520 that may be generated by one or more processors of the learning system 10. The screen 520 provides an overview of the learner's academic performance (e.g., grades) relative to other learners.

The screen 520 includes a number of visualizations. A first visualization is an overall grade visualization indicated by reference numeral 523. The visualization 523 includes a grade indicator 529 that is used to indicate the learner 73's current overall grade. The visualization 523 also includes a range 525. The range 525, indicated by a shaded area, is indicative of the second and third quartiles of the grades achieved by the class. In the example as shown, as the position of the grade marker 529 is outside the range 525 on the lower side (i.e., left towards “0”), the learner 73's grade can be determined to be in the lowest quartile of the class grades.

The screen 520 also includes a second visualization, which may be referred to as a grade chart 521. The grade chart 521 displays the learner's grades from different assessment activities completed by the learner. The assessment activities as shown include a report 526 that is worth 10%, four assignments 528 worth 25% combined, three quizzes worth 5% combined, a midterm worth 20%, two projects worth 10% combined, and a final examination that is worth 20%.

The grade chart 521 as shown is a pie-chart. In other embodiments, other suitable types of charts may be used. The radius of the grade chart 521 serves as an axis to indicate a grade from 0% and 100%.

Each type of assessment activity is laid out as a section of the grade-chart 121. The section dedicated to each activity is relative to the weight assigned to the activity. For example, the section 528 indicates the assignments 528, which are worth 25% and accordingly occupy a quarter of the pie chart. In the illustration as shown, section 526 is dedicated to reports, section 528 to assignments, section 530 to quizzes, section 532 to midterm, section 534 to projects and section 536 to the final assessment.

Within each section dedicated to one of the assessment activities, the learner's grade is indicated by reference numeral 524 similar to the visualization 521. Similarly, a shaded section 525 in each section is used to indicate second and third quartiles of the learner grades within the class. For example, if the grade 524 is within the shaded section 525, then it could be understood that the grade value indicated by the grade indicator 524. In the example as shown, the learner is in the lowest quartile for report 526, assignments 528 and projects 534 as the location of the grade 524 in sections associated with those assessment tasks is below (i.e. towards the centre or 0% grade on the radius axis) the shaded section 525. In contrast, the learner is within the second and the third quartile for quizzes 530 and midterm 532 as the grade 524 in sections associated with those assessment tasks is within the shaded section 525.

Some of the sections of the grade chart 121 also include various dividers near the outer edges of the section. For example, the section 534 has a single divider 535 bisecting the section 534 into two equal parts. The bisection of section 534 into two parts indicates that there are two assessment activities of the same type. For example, there are two projects. Furthermore, the location of the dividers indicate that relative value of each activity within the same type. As the divider 535 bisects the section 534 into two equal halves, the value of the assessment task is the same. For example, each project is worth the same amount as the other project. In contrast, the dividers 531a and 531b divide the section 530 into three parts that are not equal in size. The division of section 530 into three parts that are not equal in size indicates that two of the quizzes are worth more than the third. For example, the dividers 531a and 531b may be arranged according to the weighting of the corresponding assessment activities (e.g., quizzes, and the like).

The grade-chart visualization 521 uses plurality of integrated graphical features to convey a variety of information to a viewer. For example, it can be determined from the grade chart 521, the types of assessment activities, the number of assessment activities, the weight assigned to each type of activity, the weight assigned to each activity within the same type, the performance of the learner in each type of activity as well as performance of the learner relative to the performance of other learners in the class.

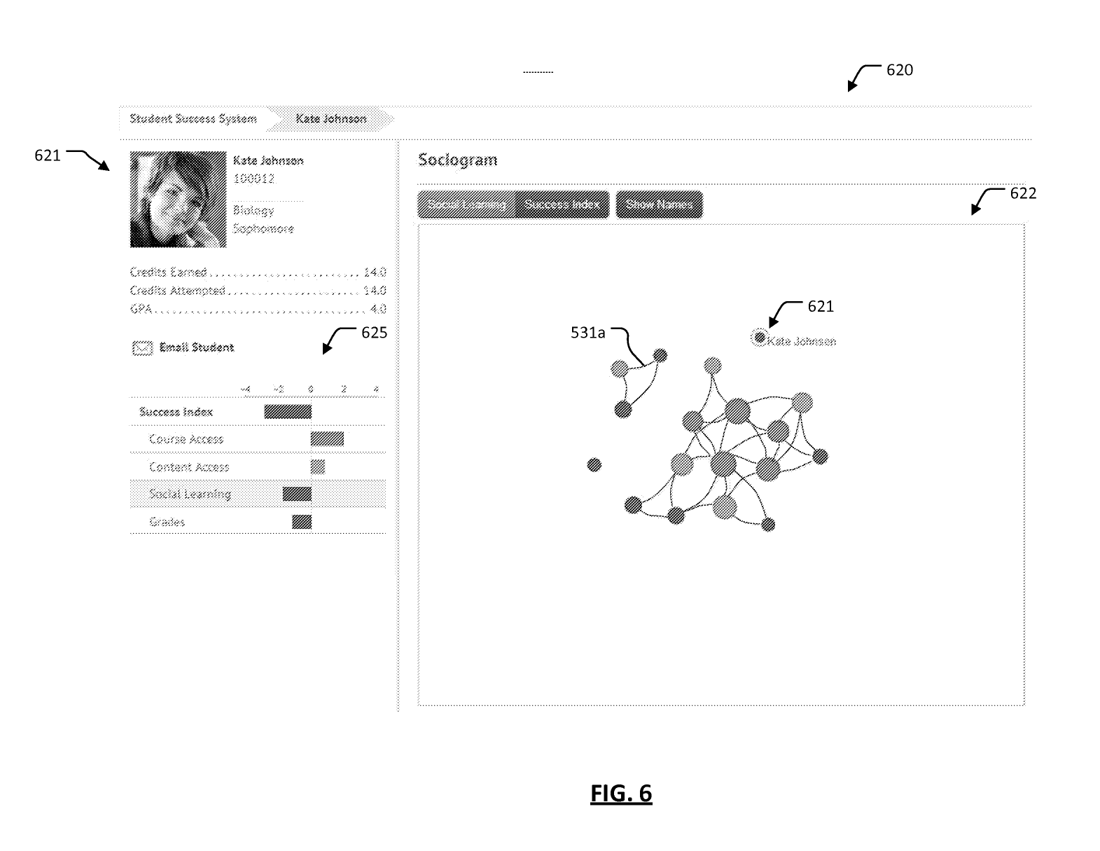

Referring now to FIG. 6, illustrated therein is a screen 620 that may be generated by one or more processors of the learning system 10. The screen 520 provides an overview of the learner's social connectedness to other learners.

The screen 620 includes a visualization, which is referred to as a sociogram 622. The sociogram 622 is generated from learner connectedness data. Each of the learners is plotted using a circular icon within the sociogram 622. The links between the icons shows the communication between the learners associated with the icons.

The size of each icon indicates the amount of social interaction that the learner associated with the icon has. For example, a larger icon size may indicate that the learner is very active socially. In contrast, a smaller size icon may indicate that the learner is not very active socially.

Furthermore, a colouring scheme could be used for the icons to indicate that risk associated with each learner. For example, the colour red could be used to indicate that the learner is at risk for not being socially connected, and the colour amber to indicate that the learner is marginally at risk of not being socially connected. The colour green can be used to indicate that the learner is socially active.

The links between the icons, for example link 624, illustrates the existence of communication between the two learners associated with the icons. In some cases, the link between the icons may be established if the amount (or extent) of communication between two learners is greater than a certain amount. For example, a link may be established more than five distinct messages are communicated between two learners. As shown, the learner 621 has no links to any other members, which suggests that the learner 621 is not very communicative with her peers.

In some cases, the amount of communication between the learners may also be used to influence the spacing or the distance between the two icons representing the learners. For example, if two learners are very communicative with each other, the icons representing the learners may be attracted to each other such that the distance between the icons are reduced. This may allow the viewer to determine groups that have been formed between the learners by observing the clustering of the icons representing the learners.

It can be observed from the loss-gain graph 625 that the social connectedness value for the learner 126 is significantly below the median social connectedness value for that class. However, it can also be observed from the graph that the learner attendance value and the learner task completion value of the learner 126 are above the median values for the class. In some such cases, an instructor may not need to be overly concerned with the performance of the learner 126 as some learners prefer to learn individually. In other cases, however, this low social engagement may still be a cause for concern.

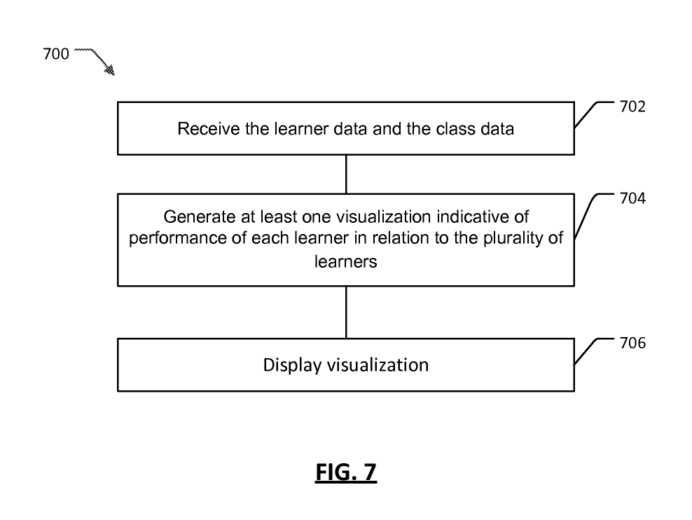

Referring now to FIG. 7, illustrated therein is a method 700 for generating a visualization in an electronic learning system according to some embodiments. The method 700 may be implemented by one or more of the processors of the system 10 described herein above.

The method beings at step 702, wherein learner data and class data are received.

At step 704, at least one visualization indicative of performance of each learner in relation to the plurality of learners is generated based upon the learner data and class data. The visualization includes multiple graphical features and each of the graphical features is indicative of one of the performance aspects of the learner relative to class data.

At step 706, the generated visualization is displayed.

It should be understood that even though the embodiments are described herein in relation to electronic learning systems, they may be applicable in other fields of technology, such as health care.

While the above description provides examples of one or more apparatus, methods, or systems, it will be appreciated that other apparatus, methods, or systems may be within the scope of the present description as interpreted by one of skill in the art. Moreover, the scope of the claims appended hereto should not be limited by the embodiments set forth in the examples, but should be given the broadest interpretation consistent with the description as a whole.

1. An electronic learning system for generating at least one visualization in relation to a plurality of learners, the system comprising:
a) at least one data storage device storing learner data and class data, the learner data having a plurality of performance aspects associated with each learner and class data being associated with the plurality of learners;
b) at least one processor in data communication with the at least one data storage device, the at least one processor adapted to:
i) receive the learner data and the class data;
ii) generate at least one visualization indicative of performance of each learner in relation to the plurality of learners based upon the learner data and class data, the at least one visualization including multiple graphical features, each of the graphical features being indicative of one of the performance aspects of the learner relative to class data; and
iii) display the at least one visualization.

2. The system of claim 1, wherein the visualization includes a loss-gain graph illustrating the learner data relative to class data.

3. The system of claim 2, wherein one of the graphical features of the visualization includes a class indicator illustrating the class data in the loss-gain graph and another of the graphical features includes a learner indicator illustrating the learner data, the relative position of the learner indicator to the class indicator being indicative of an amount of loss or gain of the learner data in comparison to the class data.

4. The system of claim 2, further comprising a plurality of learner indicators, each of the learner indicators being indicative of the learner data at a period of time such that the learner indicators illustrate change in learner data over time.

5. The system of claim 1, wherein the visualization includes a graph having a first axis indicative of grades of learners and a second axis indicative of a participation level of the learner, one of the graphical features of the graph includes a learner indicator associated the learner mapped on the graph based upon learner data, the position of the learner indicator relative to the first axis being indicative of a current grade of the learner and the position of the learner indicator relative to the second axis being indicative of a current participant level of the learner.

6. The system of claim 5, wherein the graph is further divided to include four quadrants, each of the quadrants being representative of a current status of a learner.

7. The system of claim 5, wherein one of the quadrants is indicative of under-engagement risk, the under-engagement risk being determined based upon a grade value above a defined value and has a participation level below a defined value.

8. The system of claim 5, wherein one of the quadrants is indicative of withdrawal risk, the withdrawal risk being determined based upon a grade value below a defined value and has a participation level below a defined value.

9. The system of claim 5, wherein one of the quadrants is indicative of academic under-performance risk, the withdrawal risk being determined based upon a grade value below a defined value and has a participation level above a defined value.

10. The system of claim 5, wherein one of the quadrants is indicative of predicted learner success, the predicted learner success being determined based upon a grade value above a defined value and has a participation level below a defined value.

11. The system of claim 1, wherein the visualization includes a success index indicator, the success indicator being indicative of an overall predicted level of success of the learner.

12. The system of claim 11, wherein the success index indicator includes three distinct graphical features, and one of the three features is selected based upon learner data to indicate a the overall predicted level of success of the learner.

13. The system of claim 12, wherein the first of the three distinct graphical features is indicative of a learner who is predicted to be successful, and the second of the three distinct graphical features is indicative of a learner who is marginally at risk of under-performing, and the third of the three distinct graphical features element being indicative of a learner who is at risk of under-performing.

14. The system of claim 12, wherein each of the success index elements includes a change indicator indicative of whether the success index value for the learner has increased or decreased over a period of time.

15. The system of claim 1, wherein the visualization includes a sociogram indicative of social interactions between the learner and the class.

16. The system of claim 15, wherein one of the graphical features of the visualization includes a plurality of learner indicators, each of the learner indicators being associated with a learner, and another of the graphical features of the visualization includes connectors between learner indicators, the connectors being indicative of a social interaction between the learners associated with the learner indicators.

17. The system of claim 16, wherein a proximity of one of the learner indicators to another of the learner indicators on the sociogram is indicative of the amount of social interaction between those learners.

18. The system of claim 17, wherein the learner indicators further includes a graphical feature to indicate an amount of risk associated with the learner for under-engagement.

19. The system of claim 1, wherein the visualization includes a grades graph indicative of the grades of the learner relative to class data.

20-30. (canceled)

31. A computer implemented method for generating at least one visualization in relation to a plurality of learners, the method comprising:
a) receiving learner data and the class data;
b) generating at least one visualization indicative of performance of each learner in relation to the plurality of learners based upon the learner data and class data, the at least one visualization including multiple graphical features, each of the graphical features being indicative of one of the performance aspects of the learner relative to class data; and
c) displaying the at least one visualization.
